(19) United States
(12) Patent Application Publication
(10) Pub. No.: US 2004/0123328 A1
(43) Pub. Date: Jun. 24, 2004

(54) Mobile surveillance vehicle

(75) Inventors: Christopher Lee Coffey, Manhattan Beach, CA (US); Robert Edward Coffey, El Segundo, CA (US); Lazaro Albino Lopez, Los Angeles, CA (US); Jorge Alberto Rubio, Pomona, CA (US)

Correspondence Address: KNOBBE MARTENS OLSON & BEAR LLP, 2040 MAIN STREET, FOURTEENTH FLOOR, IRVINE, CA, 92614, US

(73) Assignee: ECAMSECURE, INC., Gardena, CA

(21) Appl. No.: 10/327,014

(22) Filed: Dec. 20, 2002

(51) Int. Cl. H04N 9/47; H04N 7/18; H04N 7/173

(52) U.S. Cl. 725/105; 348/143; 348/148

(57) ABSTRACT

The invention is related to methods and apparatus that conveniently and efficiently provide video surveillance. A mobile surveillance vehicle can be towed to a site by a motor vehicle, such as a car or a truck. The mobile surveillance vehicle includes a video surveillance system, which sends video from the site over the Internet. The video can be provided with wired Internet access or with wireless Internet access. Examples of wireless Internet access include Internet access via cellular telephony and via satellite. The mobile surveillance vehicle can be self-contained such that no external hookups are used. The video can be provided to a monitoring station, which can communicate with the mobile surveillance vehicle to control video cameras. In one embodiment, video cameras can be mounted to an extendable arm or member, which can extend to provide the video cameras with an elevated perspective.

### BACKGROUND OF THE INVENTION

1. Field of the Invention

The invention generally relates to surveillance systems. In particular, the invention relates to a transportable video surveillance system.

2. Description of the Related Art

Surveillance systems, such as closed circuit television (CCTV) systems, advantageously permit a single operator to monitor relatively many locations at the same time, i.e., to be at two places at the same time. Moreover, such surveillance systems permit an operator to monitor a targeted location from a relatively safe distance in a comfortable setting, such as an indoor monitoring station. Such surveillance systems make it practical to provide security services in many locations.

However, certain types of locations are not practical to monitor using conventional CCTV systems. Examples of such locations includes construction sites, condemned sites, event sites such as concerts, damaged sites that have been damaged by flood, fire, earthquake, and the like. For these temporary venues, the cost of installing a conventional CCTV system or the time typically needed to install the system can be prohibitive. These sites are often left unmonitored, or are monitored by on-location personnel, which can be both dangerous and expensive.

What is needed is a surveillance system that is cost effective in many environments.

### SUMMARY OF THE INVENTION

Embodiments of the invention provide video surveillance that can be used in a wide variety of locations and that can be set up in relatively little time and at relatively little expense. A mobile surveillance vehicle in accordance with the present invention can be towed to a site by a motor vehicle, such as a car or a truck. In one embodiment, the mobile surveillance vehicle includes a video surveillance system, which transmits video from the site over the Internet. The communication with the Internet can be via wireless access, wired access, or both.

The mobile surveillance vehicle can be self-contained such that no external hookups are used. The video can be provided to a monitoring station, which can communicate with the mobile surveillance vehicle to control video cameras. In one embodiment, video cameras can be mounted to an arm or a pole, which can extend to provide the video cameras with an elevated perspective.

One embodiment of the invention is a mobile surveillance vehicle. The mobile surveillance vehicle includes a housing assembly wherein the housing assembly includes a hitch assembly configured to permit the mobile surveillance vehicle to be towed by a motor vehicle, where the housing assembly is further configured to carry a plurality of electronic equipment; and a surveillance sub-system wherein the surveillance sub-system is configured to take video images, where the surveillance sub-system is further configured to communicate over the Internet such that video images taken by the surveillance sub-system can be sent to a remote location. In one embodiment, the surveillance sub-system transmits the video images wirelessly to the Internet.

Another embodiment of the invention is a method of performing video surveillance. The method includes towing a mobile surveillance vehicle to a site to be monitored, wherein the mobile surveillance vehicle includes at least one video camera, a video server, and Internet access; using the video camera to monitor the site; and transmitting images from the video camera via the Internet. The Internet access can be provided by wireless Internet access or by hard-wired Internet access.

### BRIEF DESCRIPTION OF THE DRAWINGS

These and other features of the invention will now be described with reference to the drawings summarized below. These drawings and the associated description are provided to illustrate preferred embodiments of the invention and are not intended to limit the scope of the invention.

FIG. 1 is a perspective view illustrating one embodiment of a mobile surveillance vehicle.

FIG. 2 is a front view of a mobile surveillance vehicle.

FIG. 3 is a side view of a mobile surveillance vehicle.

FIG. 4 is a back view of a mobile surveillance vehicle.

FIG. 5 is another side view of a mobile surveillance vehicle.

FIG. 6 is a system diagram of a surveillance sub-system.

### DETAILED DESCRIPTION OF PREFERRED EMBODIMENTS

Although this invention will be described in terms of certain preferred embodiments, other embodiments that are apparent to those of ordinary skill in the art, including embodiments that do not provide all of the benefits and features set forth herein, are also within the scope of this invention. Accordingly, the scope of the invention is defined only by reference to the appended claims.

Embodiments of the invention advantageously provide video surveillance usable at many locations and that can be set up in relatively little time and with relatively little expense. A mobile surveillance vehicle can be towed to a site by a motor vehicle, such as a car or a truck. A heavy-duty truck or a crane is not needed to transport the mobile surveillance vehicle. The mobile surveillance vehicle includes a video surveillance system, which is configured to transmit video from the site over the Internet.

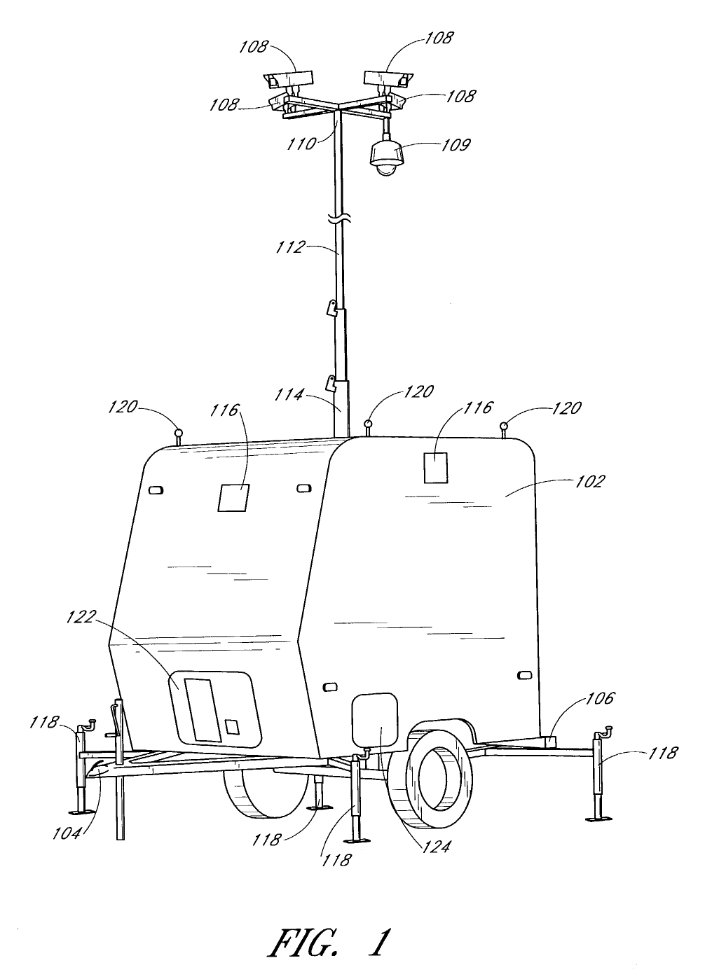

FIG. 1 is a perspective view illustrating one embodiment of a mobile surveillance vehicle. The illustrated mobile surveillance vehicle includes a housing assembly 102, which is adapted to permit the mobile surveillance vehicle to be towed by a motor vehicle. The housing assembly 102 includes an axle to permit the mobile surveillance vehicle to roll on wheels and tires. A hitch assembly 104 couples the housing assembly to the motor vehicle for towing.

In the illustrated embodiment, the mobile surveillance vehicle includes a separate frame 106 to provide attachment points for the housing assembly 102, axles, and the hitch assembly 104. In another embodiment, the frame 106 is integrated with the housing assembly 102 as in a monocoque.

The housing assembly 102 is adapted to carry a plurality of electronic equipment, such as a surveillance sub-system. The surveillance sub-system is configured to take video images and send those images over the Internet. The surveillance sub-system can also be configured to take and send audio. In one embodiment, the surveillance sub-system is configured to communicate via the Internet in a wireless manner using Cellular Digital Packet Data (CDPD). In another embodiment, the surveillance sub-system communicates via the Internet through a satellite. Satellite Internet access advantageously permits the mobile surveillance vehicle to send and receive signals in locations that are out of the range of cellular-telephone based Internet access. In another embodiment, the surveillance sub-system is configured to communicate via a hard-wired access to the Internet.

Advantageously, the wireless embodiments of the surveillance sub-system can be set up rapidly to communicate over the Internet such that video images can be received at a remote location, such as at a monitoring station. The monitoring station can be staffed by security personnel and can be configured to monitor video images from one or more mobile surveillance vehicles. The monitoring station can correspond to a nerve center location for security services that monitors one or more locations, including locations from which video images are transmitted wirelessly. It will be understood a monitoring station can also monitor another location from which video images are transmitted over land lines. It will be understood that the housing assembly 102 can be configured to hold equipment such that the equipment is accessible from an interior of the housing assembly 102 or can be configured such that the equipment is accessible from the exterior of the housing assembly 102 via an access panel. A wireless embodiment of the surveillance sub-system is described in greater detail later in connection with FIG. 6.

The mobile surveillance vehicle includes one or more video cameras 108 to take the video images for the surveillance sub-system. For example, the mobile surveillance vehicle of FIG. 1 includes four video cameras. The video cameras 108 can be attached to an extendable arm or member, such as a collapsible pole. In the illustrated embodiment of the mobile surveillance vehicle, the video cameras 108 are coupled to a distal end 110 of a telescoping pole 112. A proximal end 114 of the telescoping pole 112 is coupled to the housing assembly 102. It will be understood that the extendable member can correspond to a variety of configurations. For example, in another embodiment, the extendable member can be configured to extend and retract by folding and unfolding. In one embodiment, the extendable member is motorized such that extension and retraction of the extendable member can be operated with relative ease. Preferably, the extendable member is configured such that extension and retraction can be accomplished by a single user.

The extendable member permits the video cameras 108 to be elevated above the ground, which provides the video cameras 108 with an elevated perspective and helps to protect the video cameras 108 from vandalism. Advantageously, the extendable member can be retracted for transport of the mobile surveillance vehicle. In the illustrated mobile surveillance vehicle, the extension pieces of the telescoping pole 112 can retract substantially into the housing assembly 102 for transport. In one embodiment, a cable and pulley arrangement within the telescoping pole 112 provides the force that lifts the sections of the pole. A hand-cranked or motor-driven spool provides tension on a cable, which is affixed to the lowest portions of each of the sections. A pulley at the topmost of the lower sections changes the direction of the travel of the cable. When tension is applied to the cable, the telescoping pole 112 extends outward.

One or more of the video cameras 108 can further include controls for pan, zoom, and tilt (PZT) as illustrated in FIG. 1 by a PZT camera 109. In one embodiment, the pan, zoom, and tilt of one or more PZT cameras 109 can be independently controlled from a remote location via the communication interface. The video cameras 108 and/or video encoder can include built-in motion detection for monitoring purposes.

One or more lights 116 can be attached to the housing assembly 102 to illuminate the area to be monitored. In one embodiment, the lights 116 are mounted at a different horizontal level than the video cameras 108 to reduce glare. In one embodiment, the lights 116 correspond to four 300-Watt lights. In another embodiment, additional lights, such as four 50-Watt lights, can be automatically switched on upon the detection of motion.

One embodiment of the mobile surveillance vehicle can also include one or more legs 118 to stabilize the mobile surveillance vehicle when set up at the location to be monitored. The legs 118 can be used to level the mobile surveillance vehicle on uneven or sloped terrain, to stabilize the mobile surveillance vehicle from high winds, and the like. In the illustrated embodiment, four such legs are used to stabilize the mobile surveillance vehicle. Preferably, the legs 118 are configured to project or swing outward while in use and to collapse inward for storage and/or transport. A plurality of attachment points 120 can be used to tie the mobile surveillance vehicle to the ground via cables, ropes, and the like. Examples of attachment points 120 include hooks, eyelets, etc. When applicable, the legs 118 and/or the attachment points 120 should be used to stabilize the mobile surveillance vehicle before the telescoping pole 112 is extended. Similarly, the telescoping pole 112 should be retracted before use of the legs 118 and/or the attachment points 120 is discontinued.

The mobile surveillance vehicle can include an on-board power source such as backup batteries and/or power generators. An access panel 122 can provide access to a compartment, which can hold an on-board power generator. The power generator can provide electrical power for the mobile surveillance vehicle in the event that local AC power is not available or is not used. The power generator can also provide a backup source of power for the mobile surveillance vehicle. In one example, the mobile surveillance vehicle includes one or more batteries, such as, for example, six 105-amp-hour 12-Volt batteries, from which the electronics of the mobile surveillance vehicle, such as the surveillance sub-system, draw power. Power distribution can be configured such that the batteries provide continuous power in an uninterruptable power supply (UPS) manner. The batteries can be recharged by the power generator. The power generator can correspond to, for example, a 2-cylinder diesel-powered 4.5 kW generator with automatic starting. The automatic starting can be triggered by a timer, by detection of darkness, by switching on of lights, via remote control, etc. In one embodiment, the generator is configured to run from about dusk to about midnight. Another access panel 124 can be used to cover receptacles and the like for connection to local power sources.

One embodiment of the mobile surveillance vehicle further includes a motion sensor. The motion sensor can be coupled to the surveillance sub-system, to a vehicle alarm system, or both. The motion sensor is configured to detect tampering of the mobile surveillance vehicle and set off an alarm. The alarm can include an audible alarm and an electronically transmitted alarm message sent to the monitoring station.

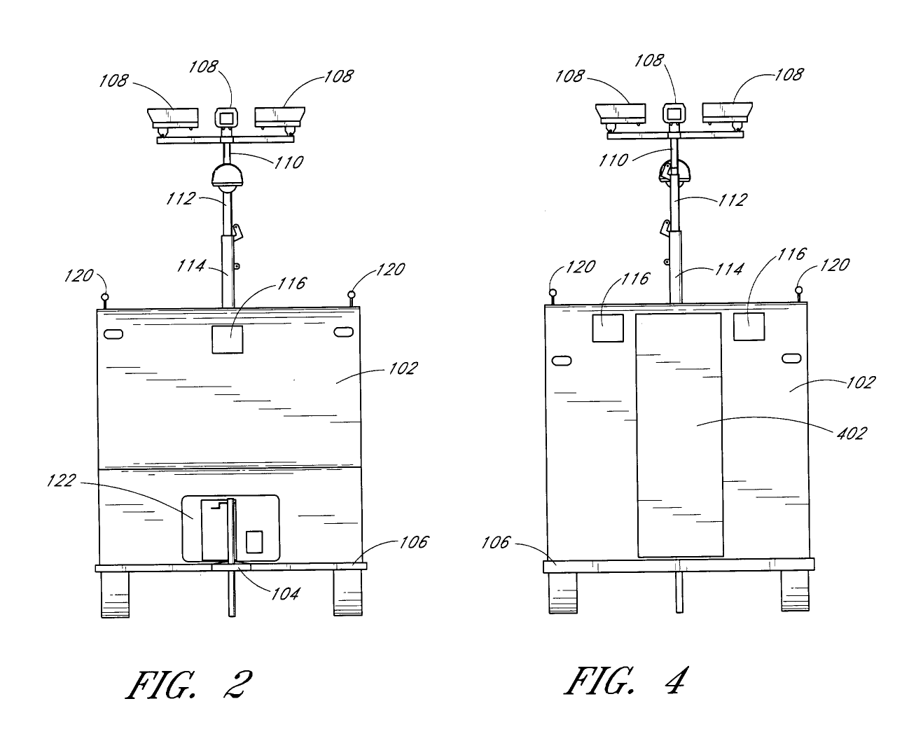

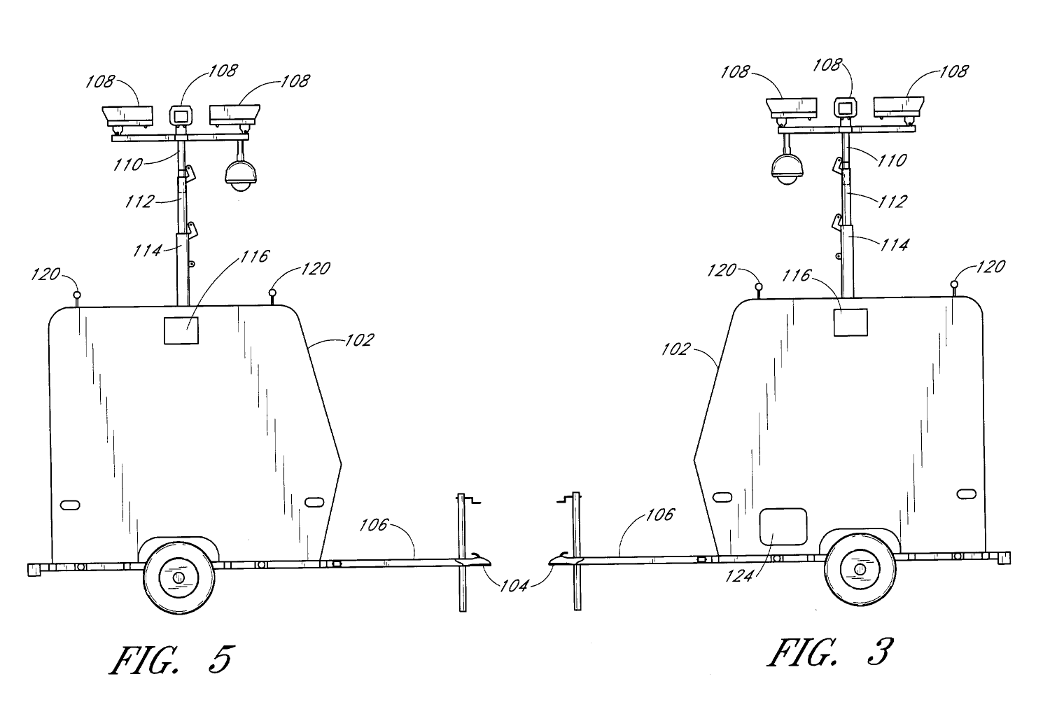

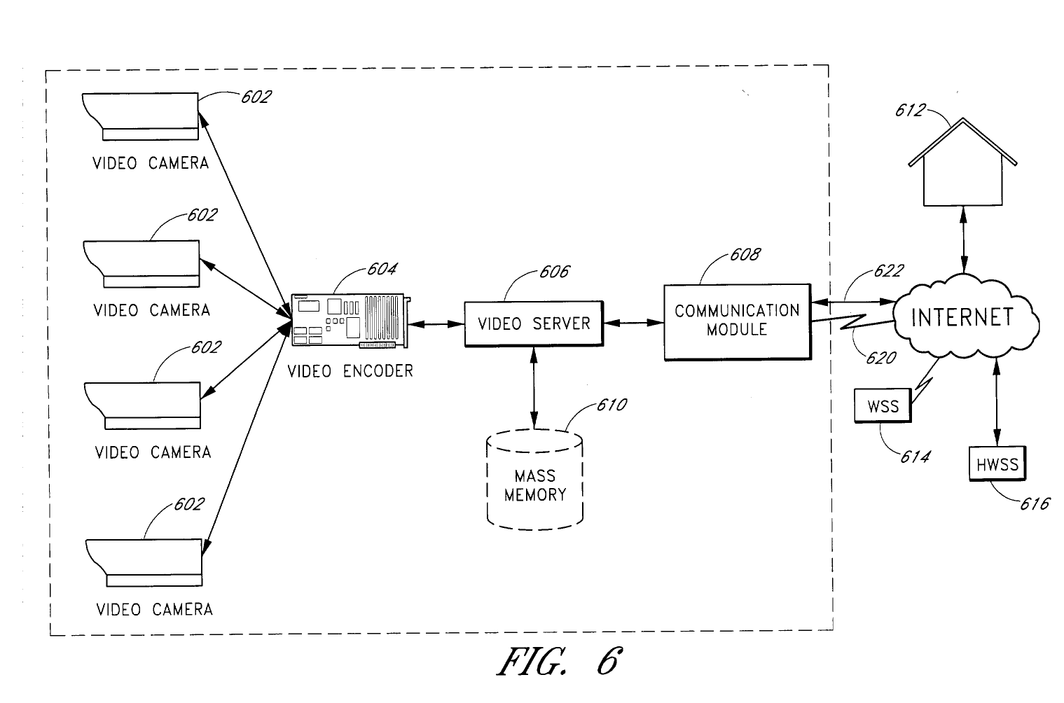

FIG. 2 is a front view of a mobile surveillance vehicle. FIG. 3 is a side view of a mobile surveillance vehicle. FIG. 4 is a back view of a mobile surveillance vehicle. FIG. 4 also illustrates a door 402 that provides access to electrical components in the housing assembly 102. FIG. 5 is another side view of a mobile surveillance vehicle.

FIG. 6 is a system diagram of a surveillance sub-system. Advantageously, wireless embodiments of the surveillance sub-system can communicate over the Internet such that video images can be received at a remote location, such as a monitoring station, without the delay and expense of installing hard lines such as DSL lines. However, it will be understood that in another embodiment, wired access to the Internet can also be used. The surveillance sub-system includes one or more video cameras 602, a video encoder 604, a video server 606, a communication module 608, and optionally includes a mass memory device 610.

The video cameras 602 can correspond to a broad variety of video cameras. In one embodiment, the video cameras 602 are configured to receive commands from the Internet to perform functions such as pan, zoom, and tilt. The video cameras 602 can be analog or digital and are coupled to the video encoder 604.

The video encoder 604 can perform analog to digital conversion for analog video cameras, can encode to a compressed format, such as MPEG, RealVideo, and the like. Examples of video encoder cards that can be used are produced by GeoVision, Inc., of Taiwan. The video encoder 604 can multiplex outputs of multiple video cameras 602. In addition, the video encoder 604 can include motion detection.

The video encoder 604 is coupled to the video server 606, which is configured to format an output of the video encoder. For example, the video encoder 604 can format the compressed output into packets for wireless transmission. An example of such a format is Cellular Digital Packet Data (CDPD).

The communication module 608 couples the video server 606 to the Internet. A variety of protocols, including connection-oriented protocols and connectionless protocols, can be used. In one embodiment, the data to and from the video server 606 is transmitted by the communication module 608 in a wireless manner. For example, wireless Internet access 620 can be provided over cellular telephone frequencies. In another embodiment, the communication module 608 communicates with the Internet via satellite. For example, the data to and from the video server 606 can be downloaded and uploaded to the satellite, and the satellite can communicate with a ground-based hub to provide the Internet access. In another embodiment, the communication module 608 communicates with the Internet via a wireless local area network (wireless LAN). Examples of wireless LANs include IEEE 802.11, Bluetooth, etc.

In another embodiment, the communication module 608 communicates with the Internet via wired access 622 such as, for example, via a T-1 line, DSL, cable modem, ISDN, dialup, etc. The data from the surveillance sub-system can be provided to a remote location, such as a monitoring station 612 that is coupled to the Internet. The monitoring station 612 can be coupled to the Internet via a variety of ways, including wireless access and wired access. Preferably, the monitoring station 612 communicates with the Internet via a T-1 line. The monitoring station 612 can also efficiently monitor other locations from other surveillance sub-systems, such as a wireless sub-system (WSS) 614 and a hard-wired sub-system (HWSS) 616.

One embodiment of the surveillance sub-system also includes the mass memory device 610, which is coupled to the video server 606. The mass memory device 610, which can include optical memory, hard disks, hard disks configured as redundant arrays of inexpensive disks (RAID), and the like, can be used to store images from the video cameras 602.

Various embodiments of the invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A mobile surveillance vehicle comprising:
a housing assembly wherein the housing assembly includes an axle and a hitch assembly configured to permit the mobile surveillance vehicle to be towed by a motor vehicle, where the housing assembly is further configured to carry a plurality of electronic equipment;
a surveillance sub-system configured to send video and to respond to commands received from the Internet, where the surveillance sub-system includes at least one video camera and a video encoder coupled to the video camera, where the video encoder is configured to encode an output of the video camera to a digital form, where the surveillance sub-system further includes a video server coupled to the video encoder, where the video server is configured to format an output of the video encoder such that video can be sent over the Internet, and where the surveillance sub-system further includes a communication module coupled to the video server, where the communication module is configured to send the compressed video format as messages over the Internet;
a plurality of lights adapted to illuminate an area proximate to the mobile surveillance vehicle;
a collapsible pole having a proximal end and a distal end, where the proximal end is coupled to the housing assembly, where the distal end is configured to hold at least one video camera, where the collapsible pole is configured to extend outward in a substantially upward direction in a first position and collapse into the housing assembly in a second position such that the video camera can be positioned at a higher elevation than the plurality of lights; and
an on-board power source with a generator.

2. The mobile surveillance vehicle as defined in claim 1, wherein the surveillance sub-system is further configured to wirelessly communicate over the Internet.

3. The mobile surveillance vehicle as defined in claim 1, wherein the surveillance sub-system is further configured to communicate over the Internet via wired Internet access.

4. The mobile surveillance vehicle as defined in claim 1, wherein the surveillance sub-system is configured to send video over the Internet via Cellular Digital Packet Data (CDPD).

5. The mobile surveillance vehicle as defined in claim 1, wherein the surveillance sub-system is configured to send video over the Internet via satellite Internet access.

6. A mobile surveillance vehicle comprising:
a housing assembly wherein the housing assembly includes an axle and a hitch assembly configured to permit the mobile surveillance vehicle to be towed by a motor vehicle, where the housing assembly is further configured to carry a plurality of electronic equipment; and
a surveillance sub-system wherein the surveillance sub-system is configured to take video and send the video over the Internet.

7. The mobile surveillance vehicle as defined in claim 6, wherein the housing assembly further comprises a trailer frame.

8. The mobile surveillance vehicle as defined in claim 6, further comprising a collapsible pole having a proximal end and a distal end, where the proximal end is coupled to the housing assembly, where the distal end is configured to hold at least one video camera, and where the collapsible pole is configured to extend outward in a substantially upward direction in a first position and collapse into the housing assembly in a second position.

9. The mobile surveillance vehicle as defined in claim 6, wherein the video camera comprises a plurality of independently controllable video cameras.

10. The mobile surveillance vehicle as defined in claim 6, further comprising a plurality of lights adapted to illuminate an area proximate to the mobile surveillance vehicle.

11. The mobile surveillance vehicle as defined in claim 6, further comprising:
a plurality of lights adapted to illuminate an area proximate to the mobile surveillance vehicle;
a collapsible pole having a proximal end and a distal end, where the proximal end is coupled to the housing assembly, and the distal end is configured to hold at least one video camera, where the collapsible pole is configured to extend outward in a substantially upward direction in a first position and collapse into the housing assembly in a second position; and
at least one video camera coupled to the collapsible pole such that the video camera is at a higher elevation than the plurality of lights.

12. The mobile surveillance vehicle as defined in claim 6, further comprising a plurality of legs that can project outward in a first position and collapse inward in a second position, where the legs are configured to stabilize the mobile surveillance vehicle.

13. The mobile surveillance vehicle as defined in claim 6, further comprising a motion sensor configured to detect tampering with the mobile surveillance vehicle, where the motion sensor is further coupled to the surveillance sub-system to trigger an alarm in response to tampering.

14. The mobile surveillance vehicle as defined in claim 6, further comprising an on-board power source that can provide electrical power to the surveillance sub-system.

15. The mobile surveillance vehicle as defined in claim 14, wherein the on-board power source comprises a generator, and where the housing assembly includes a separate externally-accessible compartment for the generator.

16. The mobile surveillance vehicle as defined in claim 6, wherein the surveillance sub-system further comprises:
at least one video camera;
a video encoder coupled to the video camera, where the video encoder is configured to encode an output of the video camera to a digital form;
a video server coupled to the video encoder, where the video server is configured to format an output of the video encoder such that it can be transmitted; and
a communication module coupled to the video server, where the communication module is configured to send the compressed video format as messages over the Internet.

17. The mobile surveillance vehicle as defined in claim 16, wherein the surveillance sub-system further comprising a mass memory device coupled to the video server, where the mass memory device is configured to store video data.

18. The mobile surveillance vehicle as defined in claim 16, wherein the communication module is further configured to wirelessly communicate over the Internet.

19. The mobile surveillance vehicle as defined in claim 16, wherein the communication module is further configured to communicate over the Internet via wired access.

20. The mobile surveillance vehicle as defined in claim 6, wherein the surveillance sub-system is further configured to be responsive to commands received from the Internet.

21. A method of performing video surveillance comprising:
towing a mobile surveillance vehicle to a site to be monitored, wherein the mobile surveillance vehicle includes at least one video camera, a video server, and is configured to provide access to the Internet;
using the video camera to monitor the site; and
sending images from the video camera via the Internet.

22. The method as defined in claim 21, further comprising:
receiving a command over the Internet; and
controlling the video camera in response to the command.

23. The method as defined in claim 21, further comprising extending a collapsible pole to which the video camera is mounted.

24. The method as defined in claim 21, wherein sending images from the video camera via the Internet further comprises transmitting the images via wireless access to the Internet.

25. The method as defined in claim 24, wherein transmitting the images via wireless access further comprises using satellite Internet access.

26. The method as defined in claim 24, wherein transmitting the images via wireless access further comprises using cellular telephony Internet access.

27. The method as defined in claim 24, wherein transmitting the images via wireless access further comprises using a wireless local area network (wireless LAN) to communicate with the Internet.

28. The method as defined in claim 21, wherein sending images from the video camera via the Internet further comprises sending the images via wired access to the Internet.
